(19) United States
(12) Patent Application Publication
(10) Pub. No.: US 2022/0282839 A1
(43) Pub. Date: Sep. 8, 2022

(54) GAS TRANSMISSION COMPRESSION OPTIMIZATION

(71) Applicant: Solar Turbines Incorporated, San Diego, CA (US)

(72) Inventors: Zachary S. Wilson, Escondido, CA (US); Cody W. Allen, Escondido, CA (US); Miroslav Levicky, Kosice (SR); Jan Imrich, Kosice (SR); Robert J. Boyhan, La Mesa, CA (US); Chad V. Palmer, San Diego, CA (US); Jonathan C. Bendert, San Diego, CA (US)

(73) Assignee: Solar Turbines Incorporated, San Diego, CA (US)

(21) Appl. No.: 17/193,289

(22) Filed: Mar. 5, 2021

(51) Int. Cl. F17D 5/00; G05B 13/04; G05B 13/02

(52) U.S. Cl. CPC F17D 5/005; G05B 13/042; G05B 13/0265

(57) ABSTRACT

Industrial machines positioned along a gas transmission pipeline are controlled using setpoints. Operators of such pipelines would benefit from real-time data and recommendations to guide them in optimizing performance of the pipelines. Accordingly, a compression optimization system is disclosed that monitors and provides real-time data and notifications, recommends optimal control setpoints using a machine-learning or other artificial-intelligence model, which may self-learn to realistically represent the pipeline, and executes simulations for hypothetical scenarios. The compression optimization system enables efficient management of the gas transmission pipeline.

### TECHNICAL FIELD

The embodiments described herein are generally directed to gas transmission, and, more particularly, to compression optimization for gas transmission in a pipeline.

### BACKGROUND

Gas transmission pipelines operate at certain pressures and flow rates to deliver gas (e.g., natural gas) to one or more destinations. Industrial machines, such as turbomachinery (e.g., including one or more compressors, turbines, and other equipment), may be positioned along a gas transmission pipeline, and configured according to target setpoints, to maintain the pressures and flow rates required to deliver the gas to the intended destination(s). It would be beneficial for operators of such gas transmission pipelines to have real-time data and recommendations to guide them in optimizing performance of the pipelines.

U.S. Pat. No. 7,720,575 (“the '575 patent”) describes optimization systems for fluid pipelines. However, the optimization systems, described in the '575 patent, are deficient in many respects. The present disclosure is directed toward overcoming one or more problems discovered by the inventors.

### SUMMARY

In an embodiment, a system is disclosed that comprises: at least one hardware processor; a memory; and one or more software modules that are configured to, when executed by the at least one hardware processor, receive real-time pipeline data representing one or more parameters of a pipeline, add the real-time pipeline data to historical pipeline data stored in the memory, execute a simulation model of the pipeline based on the real-time pipeline data, and generate one or more control setpoints, representing optimum compression, for one or more stations along the pipeline, based on an output of the simulation model.

In an embodiment, a method is disclosed that comprises using at least one hardware processor to: receive real-time pipeline data representing one or more parameters of a pipeline; add the real-time pipeline data to historical pipeline data stored in a memory; execute a simulation model of the pipeline based on the real-time pipeline data; and generate one or more control setpoints, representing optimum compression, for one or more stations along the pipeline, based on an output of the simulation model.

In an embodiment, a system is disclosed that comprises: at least one hardware processor; a memory; and one or more software modules that are configured to, when executed by at least one hardware processor, receive real-time pipeline data representing one or more parameters of a pipeline, add the real-time pipeline data to historical pipeline data stored in the memory, and use machine learning to update a simulation model, using at least a portion of the historical pipeline data as a training dataset, to minimize a difference between an output of the simulation model and at least one parameter represented in the historical pipeline data.

### BRIEF DESCRIPTION OF THE DRAWINGS

The details of embodiments of the present disclosure, both as to their structure and operation, may be gleaned in part by study of the accompanying drawings, in which like reference numerals refer to like parts, and in which:

FIG. 1 illustrates an example infrastructure in which one or more of the disclosed processes may be implemented, according to an embodiment;

FIG. 2 illustrates an example processing system by which one or more of the disclosed processes may be implemented, according to an embodiment;

FIG. 3 illustrates an example compression optimization system, according to an embodiment; and

FIG. 4 illustrates an example graphical user interface for compression optimization, according to an embodiment.

### DETAILED DESCRIPTION

The detailed description set forth below, in connection with the accompanying drawings, is intended as a description of various embodiments, and is not intended to represent the only embodiments in which the disclosure may be practiced. The detailed description includes specific details for the purpose of providing a thorough understanding of the embodiments. However, it will be apparent to those skilled in the art that embodiments of the invention can be practiced without these specific details. In some instances, well-known structures and components are shown in simplified form for brevity of description.

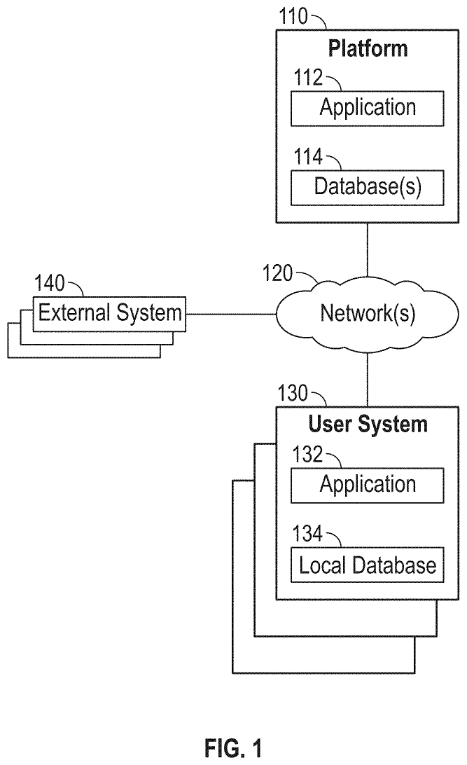

FIG. 1 illustrates an example infrastructure in which one or more of the disclosed processes may be implemented, according to an embodiment. The infrastructure may comprise a platform 110 (e.g., one or more servers) which hosts and/or executes one or more of the various processes (e.g., implemented as software) described herein. Platform 110 may comprise dedicated servers, or may instead comprise cloud instances, which utilize shared resources of one or more servers. These servers may be collocated and/or geographically distributed. Platform 110 may also comprise a server application 112 and/or one or more databases 114. In addition, platform 110 may be communicatively connected to one or more user systems 130 via one or more networks 120. Platform 110 may also be communicatively connected to one or more external systems 140 (e.g., sensor systems, other platforms, websites, etc.) via one or more networks 120.

Network(s) 120 may comprise the Internet, and platform 110 may communicate with user system(s) 130 and/or external system(s) 140 through the Internet using standard transmission protocols, such as HyperText Transfer Protocol (HTTP), HTTP Secure (HTTPS), File Transfer Protocol (FTP), FTP Secure (FTPS), Secure Shell FTP (SFTP), and the like, as well as proprietary protocols. While platform 110 is illustrated as being connected to various systems through a single set of network(s) 120, it should be understood that platform 110 may be connected to the various systems via different sets of one or more networks. For example, platform 110 may be connected to a subset of user systems 130 and/or external systems 140 via the Internet, but may be connected to one or more other user systems 130 and/or external systems 140 via an intranet. Furthermore, while only a few user systems 130 and external systems 140, one server application 112, and one set of database(s) 114 are illustrated, it should be understood that the infrastructure may comprise any number of user systems, external systems, server applications, and databases.

User system(s) 130 may comprise any type or types of computing devices capable of wired and/or wireless communication, including without limitation, desktop computers, laptop computers, tablet computers, smart phones or other mobile phones, servers, televisions, set-top boxes, electronic kiosks, and/or the like.

Platform 110 may comprise web servers which host one or more websites and/or web services. In embodiments in which a website is provided, the website may comprise a graphical user interface, including, for example, one or more screens (e.g., webpages) generated in HyperText Markup Language (HTML) or other language. Platform 110 transmits or serves one or more screens of the graphical user interface in response to requests from user system(s) 130. In some embodiments, these screens may be served in the form of a wizard, in which case two or more screens may be served in a sequential manner, and one or more of the sequential screens may depend on an interaction of the user or user system 130 with one or more preceding screens. The requests to platform 110 and the responses from platform 110, including the screens of the graphical user interface, may both be communicated through network(s) 120, which may include the Internet, using standard communication protocols (e.g., HTTP, HTTPS, etc.). These screens (e.g., webpages) may comprise a combination of content and elements, such as text, images, videos, graphs, tables, animations, references (e.g., hyperlinks), frames, inputs (e.g., textboxes, text areas, checkboxes, radio buttons, drop-down menus, buttons, forms, etc.), scripts (e.g., JavaScript), and the like, including elements comprising or derived from data stored in one or more databases (e.g., database(s) 114) that are locally and/or remotely accessible to platform 110.

Platform 110 may further comprise, be communicatively coupled with, or otherwise have access to one or more database(s) 114. For example, platform 110 may comprise one or more database servers which manage one or more databases 114. A user system 130 or server application 112 executing on platform 110 may submit data (e.g., user data, form data, etc.) to be stored in database(s) 114, and/or request access to data stored in database(s) 114. Any suitable database may be utilized, including without limitation MySQL™, Oracle™ IBM™, Microsoft SQL™, Access™, PostgreSQL™, and the like, including cloud-based databases and proprietary databases. Data may be sent to platform 110, for instance, using the well-known POST request supported by HTTP, via FTP, and/or the like. This data, as well as other requests, may be handled, for example, by server-side web technology, such as a servlet or other software module (e.g., comprised in server application 112), executed by platform 110.

In embodiments in which a web service is provided, platform 110 may receive requests from external system(s) 140, and provide responses in eXtensible Markup Language (XML), JavaScript Object Notation (JSON), and/or any other suitable or desired format. In such embodiments, platform 110 may provide an application programming interface (API) which defines the manner in which user system(s) 130 and/or external system(s) 140 may interact with the web service. Thus, user system(s) 130 and/or external system(s) 140 (which may themselves be servers), can define their own user interfaces, and rely on the web service to implement or otherwise provide the backend processes, methods, functionality, storage, and/or the like, described herein.

For example, in such an embodiment, a client application 132 (e.g., with access to a local database 134) executing on one or more user system(s) 130 may interact with a server application 112 executing on platform 110 to execute one or more or a portion of one or more of the various processes described herein. Client application 132 may be “thin,” in which case processing is primarily carried out server-side by server application 112 on platform 110. A basic example of a thin client application 132 is a browser application, which simply requests, receives, and renders webpages at user system(s) 130, while server application 112 on platform 110 is responsible for generating the webpages and managing database functions. Alternatively, the client application may be “thick,” in which case processing is primarily carried out client-side by user system(s) 130. It should be understood that client application 132 may perform an amount of processing, relative to server application 112, at any point along this spectrum between “thin” and “thick,” depending on the design goals of the particular implementation. Thus, the software implementing the disclosed process(es) may simply be referred to herein as “the application,” and it should be understood that this application may wholly reside on either platform 110 (e.g., in which case server application 112 performs all processing) or user system(s) 130 (e.g., in which case client application 132 performs all processing), or be distributed between platform 110 and user system(s) 130 (e.g., in which case server application 112 and client application 132 both perform processing). In any case, the application may comprise one or more executable software modules that implement one or more of the processes described herein, including the disclosed compression optimization.

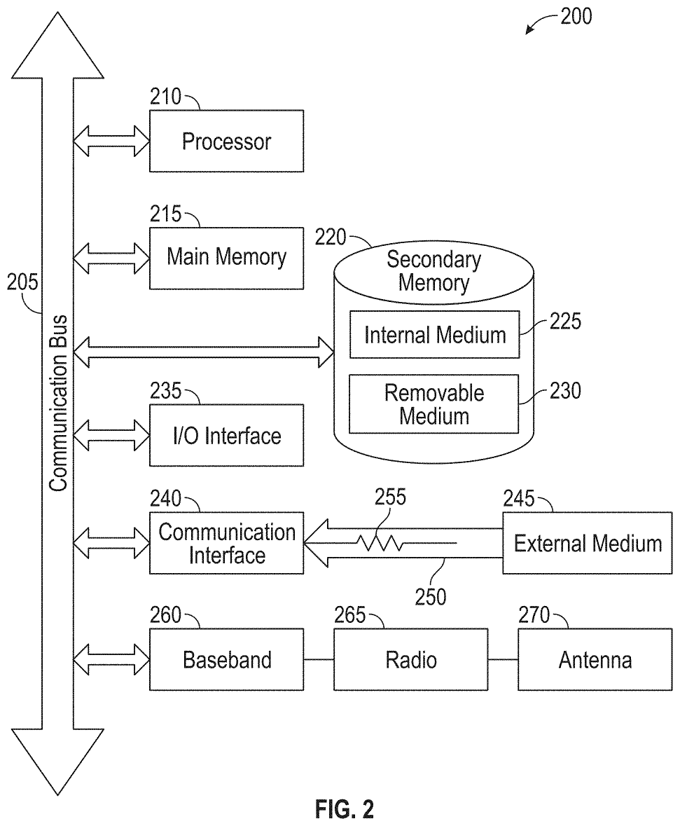

FIG. 2 is a block diagram illustrating an example wired or wireless system 200 that may be used in connection with various embodiments described herein. For example, system 200 may be used to execute one or more of the processes (e.g., implemented as software modules of the application) described herein, and may represent components of platform 110, user system(s) 130, external system(s) 140, and/or other processing devices described herein. System 200 can be a server, conventional personal computer (e.g., desktop computer), mobile processing device (e.g., laptop computer, tablet computer, smart phone, etc.), or any other processor-enabled device that is capable of wired or wireless data communication. Other computer systems and/or architectures may be also used, as will be clear to those skilled in the art.

System 200 may comprise one or more processors, such as processor 210, which may comprise a central processing unit (CPU). Additional processors may be provided, such as an auxiliary processor to manage input/output, an auxiliary processor to perform floating-point mathematical operations, a special-purpose microprocessor having an architecture suitable for fast execution of signal-processing algorithms (e.g., digital-signal processor), a slave processor subordinate to the main processing system (e.g., back-end processor), an additional microprocessor or controller for dual or multiple-processor systems, and/or a coprocessor. Such auxiliary processors may be discrete processors or may be integrated with processor 210.

Processor 210 may be connected to a communication bus 205. Communication bus 205 may include a data channel for facilitating information transfer between storage and other peripheral components of system 200. Furthermore, communication bus 205 may provide a set of signals used for communication with processor 210, including a data bus, address bus, and/or control bus (not shown). Communication bus 205 may comprise any standard or non-standard bus architecture such as, for example, bus architectures compliant with industry standard architecture (ISA), extended industry standard architecture (EISA), Micro Channel Architecture (MCA), peripheral component interconnect (PCI) local bus, standards promulgated by the Institute of Electrical and Electronics Engineers (IEEE) including IEEE 488 general-purpose interface bus (GPM), IEEE 696/S-100, and/or the like.

System 200 may comprise a main memory 215, and may also comprise a secondary memory 220. Main memory 215 provides storage of instructions and data for software modules executing on processor 210, such as one or more software modules of the disclosed application. It should be understood that programs stored in the memory and executed by processor 210 may be written and/or compiled according to any suitable language, including without limitation C/C++, Java, JavaScript, Perl, Visual Basic, .NET, and the like. Main memory 215 is typically semiconductor-based memory, such as dynamic random access memory (DRAM) and/or static random access memory (SRAM). Other semiconductor-based memory types include, for example, synchronous dynamic random access memory (SDRAM), Rambus dynamic random access memory (RDRAM), ferroelectric random access memory (FRAM), and the like, including read-only memory (ROM).

Secondary memory 220 may comprise a non-transitory computer-readable medium having computer-executable code (e.g., software modules of the disclosed application) and/or other data stored thereon. The code and/or data stored on secondary memory 220 may be read into main memory 215 for execution by processor 210. Secondary memory 220 may optionally include an internal medium 225 and/or a removable medium 230. Removable medium 230 may be read from and/or written to in any well-known manner. Removable storage medium 230 may be, for example, a magnetic tape drive, a compact disc (CD) drive, a digital versatile disc (DVD) drive, other optical drive, a flash memory drive, and/or the like.

Alternatively or additionally, secondary memory 220 may comprise other similar means for allowing instructions or data to be loaded into system 200. Such means may include, for example, a communication interface 240, which allows software and data to be transferred from external storage medium 245 to system 200. Examples of external storage medium 245 may include an external hard disk drive, an external optical drive, an external magneto-optical drive, and/or the like. Other examples of secondary memory 220 may include semiconductor-based memory, such as programmable read-only memory (PROM), erasable programmable read-only memory (EPROM), electrically erasable read-only memory (EEPROM), and flash memory (block-oriented memory similar to EEPROM).

As mentioned above, system 200 may include a communication interface 240. Communication interface 240 allows data to be transferred between system 200 and external devices (e.g. printers), networks, or other information sources. For example, software may be transferred to system 200 from a network server (e.g., platform 110) via communication interface 240. Examples of communication interface 240 include a built-in network adapter, network interface card (NIC), Personal Computer Memory Card International Association (PCMCIA) network card, card bus network adapter, wireless network adapter, Universal Serial Bus (USB) network adapter, modem, a wireless data card, a communications port, an infrared interface, an IEEE 1394 fire-wire, and any other device capable of interfacing system 200 with a network (e.g., network(s) 120) or another computing device. Communication interface 240 preferably implements industry-promulgated protocol standards, such as Ethernet IEEE 802 standards, Fiber Channel, digital subscriber line (DSL), asynchronous digital subscriber line (ADSL), frame relay, asynchronous transfer mode (ATM), integrated digital services network (ISDN), personal communications services (PCS), transmission control protocol/Internet protocol (TCP/IP), serial line Internet protocol/point to point protocol (SLIP/PPP), and so on, but may also implement customized or non-standard interface protocols as well.

Data transferred via communication interface 240 are generally in the form of electrical communication signals 255. These signals 255 may be provided to communication interface 240 via a communication channel 250. In an embodiment, communication channel 250 may be a wired or wireless network (e.g., network(s) 120), or any variety of other communication links. Communication channel 250 carries signals 255 and can be implemented using a variety of wired or wireless communication means including wire or cable, fiber optics, conventional phone line, cellular phone link, wireless data communication link, radio frequency (“RF”) link, or infrared link, just to name a few.

Computer-executable code (e.g., such as software modules of the disclosed application) is stored in main memory 215 and/or secondary memory 220. Such code can also be received via communication interface 240 and stored in main memory 215 and/or secondary memory 220. Such code, when executed, enable system 200 to perform the various processes described elsewhere herein.

In this description, the term “computer-readable medium” is used to refer to any non-transitory computer-readable storage media used to provide computer-executable code and/or other data to or within system 200. Examples of such media include main memory 215, secondary memory 220 (including internal memory 225, removable medium 230, and external storage medium 245), and any peripheral device communicatively coupled with communication interface 240 (including a network information server or other network device). These non-transitory computer-readable media are means for providing software and/or other data to system 200.

In an embodiment, I/O interface 235 provides an interface between one or more components of system 200 and one or more input and/or output devices. Example input devices include, without limitation, sensors, keyboards, touch screens or other touch-sensitive devices, biometric sensing devices, computer mice, trackballs, pen-based pointing devices, and/or the like. Examples of output devices include, without limitation, other processing devices, cathode ray tubes (CRTs), plasma displays, light-emitting diode (LED) displays, liquid crystal displays (LCDs), printers, vacuum fluorescent displays (VFDs), surface-conduction electron-emitter displays (SEDs), field emission displays (FEDs), and/or the like. In some cases, an input and output device may be combined, such as in the case of a touch panel display (e.g., in a smart phone, tablet computer, or other mobile device).

System 200 may also include optional wireless communication components that facilitate wireless communication over a voice network and/or a data network (e.g., in the case of user system 130). The wireless communication components may comprise an antenna system 270, a radio system 265, and a baseband system 260. In system 200, radio frequency (RF) signals are transmitted and received over the air by antenna system 270 under the management of radio system 265.

In an embodiment, antenna system 270 may comprise one or more antennae and one or more multiplexors (not shown) that perform a switching function to provide antenna system 270 with transmit and receive signal paths. In the receive path, received RF signals can be coupled from a multiplexor to a low noise amplifier (not shown) that amplifies the received RF signal and sends the amplified signal to radio system 265.

In an alternative embodiment, radio system 265 may comprise one or more radios that are configured to communicate over various frequencies. In an embodiment, radio system 265 may combine a demodulator (not shown) and modulator (not shown) in one integrated circuit (IC). The demodulator and modulator can also be separate components. In the incoming path, the demodulator strips away the RF carrier signal leaving a baseband receive audio signal, which is sent from radio system 265 to baseband system 260.

If the received signal contains audio information, then baseband system 260 decodes the signal and converts it to an analog signal. Then the signal is amplified and sent to a speaker. Baseband system 260 also receives analog audio signals from a microphone. These analog audio signals are converted to digital signals and encoded by baseband system 260. Baseband system 260 also encodes the digital signals for transmission and generates a baseband transmit audio signal that is routed to the modulator portion of radio system 265. The modulator mixes the baseband transmit audio signal with an RF carrier signal, generating an RF transmit signal that is routed to antenna system 270 and may pass through a power amplifier (not shown). The power amplifier amplifies the RF transmit signal and routes it to antenna system 270, where the signal is switched to the antenna port for transmission.

Baseband system 260 is also communicatively coupled with processor 210. Data can be received from baseband processor 260 and stored in main memory 210 or in secondary memory 220, or executed upon receipt. Software, received from baseband system 260, may be executed by processor 210 to enable system 200 to perform one or more of the various processes described herein.

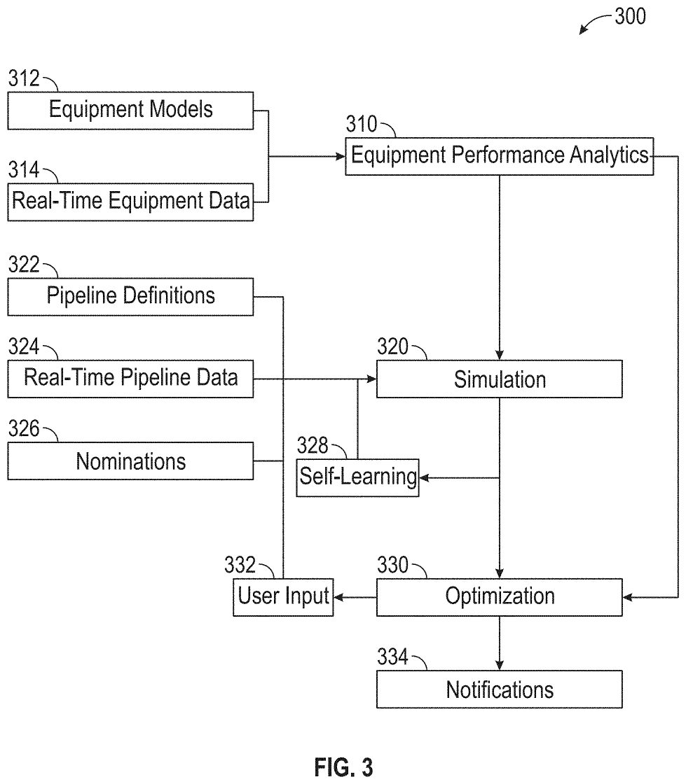

FIG. 3 illustrates the components and data flow of a compression optimization system, implemented by the disclosed application, according to an embodiment. As discussed elsewhere herein, compression optimization system 300 may be implemented as server application 112, client application 132, or a combination of a server application 112 and client application 132.

In the illustrated embodiment, compression optimization system 300 comprises an equipment performance analytics module 310, a simulation module 320, and an optimization module 330. Equipment performance analytics module 310 may receive equipment models 312 and real-time equipment data 314 as input, and output analytic results, representing real-time conditions of the equipment, to simulation module 320. Simulation module 320 may receive the analytic results from equipment performance analytics module 310, as well as pipeline definitions 322, real-time pipeline data 324, and nominations 326, and output a simulation result to optimization module 330. Optionally, simulation module 320 may also output simulation results to a self-learning module 328, which may analyze the simulation results and output modifications to simulation module 320, to update the model used by simulation module 320, as equipment conditions evolve in the physical pipeline. Optimization module 330 may receive the simulation results, output by simulation module 320, and output recommended parameters (e.g., control setpoints) for operating the physical pipeline with optimized compression. In addition, optimization module 330 may prompt and/or receive user inputs 332, as well as output or initiate notifications 334 when one or more criteria are met. User inputs 332 (e.g., optimization preferences, what-if scenarios, model requirements, etc.) may be used to modify or regulate the model used by simulation module 320 according to user preferences and/or requirements.

It should be understood that each of the disclosed modules, including equipment performance analytics module 310, simulation module 320, self-learning module 328, and optimization module 330, as well as the various inputs and outputs, may be implemented in software, for example, as separate software modules that communicate via one or more APIs or other means, directly (e.g., locally on the same system 200) or indirectly (e.g., via one or more networks, such as network 120), and/or using any other standard or non-standard means, or as a single integrated software application comprising all of the various modules. In addition, any one or more of the described components may be omitted in various embodiments. For example, self-learning module 328 may be omitted in an embodiment that does not utilize self-learning to adjust the simulation model, user-input 332 may be omitted in an embodiment that does not allow user input to the simulation model, and/or notifications 334 may be omitted in an embodiment which does not utilize notifications. In addition, the described components may be integrated or communicatively coupled with other components that are not described herein. It should be understood that there may be various advantages and disadvantages to including or omitting a particular component.

Equipment models 312 may comprise data structures that store representations of the attributes (e.g., parameters, limits, structural and/or behavioral models, materials, etc.) of physical equipment in the pipeline and otherwise supporting the pipeline. Examples of such equipment include, without limitation, gas compressors, gas turbines, valves, and/or the like. One or more equipment models 312 may be generated by the original equipment manufacturer (OEM) and imported into equipment performance analytics module 310. Alternatively or additionally, one or more equipment models 312 may be generated based on equipment specifications provided by the OEM(s). In either case, each equipment model 312 may comprise a realistic representation of the item of equipment to which it corresponds. All equipment that significantly affects compression in the pipeline may have a corresponding equipment model 312.

Real-time equipment data 314 may represent live data being output by or sensed in physical equipment in the pipeline. As used herein, the term “real-time” includes both an occurrence that is simultaneous with an event, as well as a contemporaneous occurrence that is within a small delay period (e.g., milliseconds, seconds, etc.) from an event, caused by, for example, processing and/or communication latencies. Real-time equipment data 314 may be generated by one or more sensors in physical equipment being monitored. It should be understood that one or more, including potentially all, of the physical equipment being monitored and from which real-time equipment data 314 is being received may be represented in at least one of equipment models 312.

Equipment performance analytics module 310 analyzes real-time equipment data 314, in real time, with reference to equipment models 312, and outputs results indicating one or more parameters of each item of equipment for which real-time equipment data 314 was received. For example, real-time equipment data 314 received for an item of equipment in the pipeline may be input into, or otherwise used with, an equipment model 312, representing that equipment, to produce an output that represents one or more real-time conditions of the physical equipment. Thus, the output of equipment performance analytics module 310 for a particular item of equipment may comprise one or more conditions and/or performance metrics of the equipment, as determined from the equipment model 310 and real-time equipment data 314 for that particular item of equipment. These real-time conditions may be provided by equipment performance analytics module 310 to simulation module 320, so that the equipment represented in a simulation model used by simulation module 320 may be updated with real-time conditions of that equipment.

Simulation module 320 may comprise one or a plurality of steady-state simulation models that represent the physical pipeline in a steady state. In an embodiment, the pipeline may be represented as a plurality of segments, to enable more realistic modeling. Each of the plurality of segments of pipeline corresponds to a starting point and delivery point in the pipeline, and may be represented by its own steady-state model. Each model may comprise an expression or other algorithm with one or more coefficients and one or more variables corresponding to inputs. The variables in each model may correspond to parameters in the output of equipment performance analytics module 310, pipeline definitions 322, real-time pipeline data 324, and/or nominations 326. Values for these parameters may be input into a given model, and the model may be evaluated to calculate an output parameter value from the input parameter values. It should be understood that the output parameter value for a given model represents that model's prediction of that parameter value based on the input parameter values. In an embodiment which utilizes a plurality of models (e.g., representing a plurality of segments of the pipeline), the output parameter values of two or more, and potentially all, of the plurality of models may be further evaluated, according to one or more additional models, to produce an aggregate output parameter value for the pipeline.

In an embodiment, the parameter value output by simulation module 320 comprises the pipeline capacity. Pipeline capacity refers to the maximum amount of gas that can be delivered to all delivery points along the pipeline under a given set of conditions. Pipeline capacity may be calculated from the values of one or more, including potentially all, of asset availability in the pipeline, gas conditions, gas constraints, ambient conditions, and/or the like. For example, pipeine capacity may be calculated from the values of one or more, including potentially all, of the following input parameters: ambient temperature at each compression site (e.g., impacting available power from gas turbine drivers), gas compressor availability (e.g., if a gas compressor is unavailable due to maintenance or repair, pipeline capacity will be reduced), driver and gas compressor performance degradation, minimum deliver pressure requirements, and/or maximum gas receipt pressures or gas receipt flow limitations.

The complexity of the simulation model (which may comprise a plurality of models) may be reduced, where possible, to improve calculation speed and enable modeling that is suitable for real-time analysis. For example, to calculate pipeline capacity quickly and efficiently, parameters that have minimal effect on accuracy can be assumed, rather than separately calculated. In addition, piecewise linear functions may be used to approximate the boundaries of each compressor map for each compressor in the pipeline, and the isentropic head value for each compressor in the pipeline may be approximated using a first order Taylor expansion about a point that is close to expected capacity conditions. In other words, a curve can be approximated as a set of straight lines, according to whatever accuracy is desired or required. Collectively, this set of straight lines are a set of piecewise linear functions. A Taylor expansion is applied at a point to obtain a linear function, as opposed to the multivariable, nonlinear scalar function that is well-known for calculating the isentropic head. These simplifications negligibly affect accuracy, but reduce the complexity of the pipeline capacity solution to a non-convex quadratic inequality, which enables the use of a commercial-grade solver (e.g., Gurobi™ Optimizer by Gurobi Optimization, LLC, of Beaverton, Oreg.; Mosek™ Optimizer by MOSEK ApS of Copenhangen, Denmark; CPLEX™ by IBM Corp. of Armonk, N.Y.; GAMS™ Solver by GAMS Development Corp. of Fairfax, Va.; etc.). Thus, the pipeline capacity can be calculated quickly and reliably, with an accuracy that is acceptable for informing operational decisions and tracking the available performance level of the pipeline over time.

In an embodiment, a self-learning module 328 is used to update the simulation model of simulation module 320 to more accurately reflect the actual pipeline and to evolve with changing conditions in the pipeline over time. For example, the simulation model may initially comprise an algorithm based on a theoretical model of the pipeline. However, this initial simulation model may not accurately reflect the actual pipeline due to inevitable deviations from the theoretical model.

Thus, in an embodiment, simulation module 320 receives pipeline definitions 322, real-time pipeline data 324, and/or nominations 326, in addition to the equipment conditions from equipment performance analytics module 310, in order to train the simulation model to more accurately reflect the actual pipeline and to evolve with the pipeline over time. Pipeline definitions 322 may comprise data structures that store representations of the attributes of physical pipeline segments. Real-time pipeline data 324 may represent live data being output from one or more metering stations along the physical pipeline. For example, each metering station may comprise one or more sensors that collect and transmit data (e.g., flow rate, suction pressure, discharge pressure, suction temperature, discharge temperature, etc. at the metering station) to simulation module 320. Nominations 326 may comprise data structures that store representations of customer-defined gas nominations for one or more gas customers. Each gas nomination may indicate, for an associated customer, a volume of gas to be delivered to a facility of the associated customer over a defined period of time. Each customer's gas nomination may be input via a graphical user interface (e.g., generated by server application 112 and displayed on a user system 130). Alternatively, each gas nomination may be transmitted from a customer's management system to server application 112 (e.g., via an API), with or without user intervention, for a seamless user experience. In this case, nominations 326 may be updated in real-time as conditions and customer's nominations change.

Self-learning module 328 may periodically execute simulation module 320 to input the values of input parameters, extracted from the received data (i.e., representing actual values of the input parameters), into the steady-state simulation model to output a predicted parameter value. This may be done at certain time intervals, whenever new data is received, and/or according to any other periodicity. Self-learning module 328 may also extract or derive the actual value of the output parameter value, for the given input parameter values, from the received data. For example, self-learning module 328 may extract a set of actual parameter values, comprising values for the input parameter(s) to the simulation model and the output parameter (e.g., pipeline capacity) of the simulation model, from real-time pipeline data 324 (e.g., as obtained from compressors and/or metering stations). In an embodiment, self-learning module 328 may only use such data from equipment that is operating near steady-state conditions. Steady-state conditions may be identified as actual flow rates, temperatures, and pressures that have little to no variation for a defined period of time.

If the difference between the predicted parameter value, output by the simulation model, and the actual parameter value is significant (e.g., greater than a threshold), self-learning module 328 may initiate a training session to adjust the simulation model using machine learning or other artificial intelligence, according to a training dataset. Typically, significant differences will occur infrequently, since equipment does not usually change dramatically from day to day. The training dataset may comprise historical values of correlated input and output parameter values (e.g., in real-time pipeline data 324) that have been collected over time for the pipeline. Self-learning module 328 may execute one or more machine-learning algorithms that adjust coefficients in the simulation model to minimize the difference between the predicted parameter value, output by the simulation model for input parameter values in the training dataset, and the actual parameter values correlated to those input parameter values in the training dataset.

When trained, the simulation model is able to accurately predict the parameter value (e.g., pipeline capacity) for any given set of input parameter values (e.g., representing any set of conditions) at any point in time. Notably, such training can be used to continually adjust the simulation model over any period of time to accurately reflect operation of the current pipeline. Thus, as the pipeline changes over time (e.g., due to deterioration or maintenance of the equipment), the simulation model will be automatically updated in parallel by self-learning module 328 to reflect the changes in the pipeline. For example, degradations in the horsepower of gas turbine drivers over time, increases in flow resistance within pipes, and the like, will be automatically reflected in the simulation model. It should be understood that these changes in the pipeline may be reflected in the simulation model by adjusting one or more coefficients in the simulation model. As an example, a change in flow resistance within a segment of the pipeline may be reflected by an adjustment to a friction factor in the model for that segment.

In an embodiment, simulation module 320 may comprise a transient simulation model, in addition to or instead of a steady-state simulation model. The transient simulation model, which may operate in a similar manner to the steady-state simulation model, can provide real-time transient analysis of upset conditions to forecast the rate of change of pipeline capacity (e.g., within a graphical user interface of optimization module 330) over a time period between steady states, as a result of a change in one or more conditions of the pipeline. In other words, transient analysis can indicate the length of time that it will take the pipeline to go from one flow condition to another flow condition in a given scenario. This rate of change can be visually displayed to a user via a graphical user interface. Thus, for example, if the operator plans to shut down a main valve, the transient simulation can determine how long it will take the equipment to shut down and for pipeline capacity to drop. This can greatly inform decision-making.

A transient simulation can be initiated by a user as a hypothetical (i.e., what-if) analysis, and/or be automatically triggered by a change in real-time pipeline data 324 (e.g., an upset condition). Transient flows through the pipeline are time-dependent and require differential equations to be solved. In an embodiment, for what-if analysis, the solver for the transient simulation model utilizes a set of boundary conditions that are input by a user (e.g., via a graphical user interface of optimization module 330). For event-triggered forecasts, the solver may utilize a set of boundary conditions that are input by a user (e.g., via the graphical user interface of optimization module 330) in combination with operational data (e.g., real-time pipeline data 324). In this case, optimization module 330 may notify a user of the event (e.g., via a notification 334), as well as provide the user with the forecasted rate of change in pipeline capacity, to enable the user to make an informed decision quickly. In any case, the solver for the transient simulation may output flow rates and pressure values at nodes in the pipeline (e.g., at metering stations), in association with timestamps.

In an embodiment, the solver for the transient simulation uses the one-dimensional Navier-Stokes (1DNS) equation, with modifications for the internal flow of pipes, and linearizes about deviations from the steady-state boundary values. Navier-Stokes equations are nonlinear field equations that govern the flow of fluids. In this embodiment, these equations are modified to represent gas flow in a single direction through a pipe. The nonlinearized terms get linearized using the Taylor expansion, which eliminates nonlinear terms. The Laplace integral transform may then be applied to the linearized deviation equation to yield a set of transfer functions. The Laplace integral transform converts differential equations into algebraic equations, which are easier to work with and solve than differential equations. The resulting transfer functions can then be re-represented in a state space format, for which efficient numerical solvers exist and can be used to produce a solution. The state space representation makes the transfer functions more manageable for the solver.

In an embodiment, since pipelines often operate in a slow transient state, the pipeline is modeled in the transient model as a plurality of smaller segments, to achieve a proper comparison of predicted and actual values. Since instrumentation error can interfere with these calculations, the hardware should be properly maintained and upgraded if necessary.

In an embodiment, the simulation model of simulation module 320 may be trained, as described above, to output a set of control setpoints for controlling one or more stations along the pipeline, given a set of input conditions and/or preferences. This may be in addition to or instead of outputting predicted pipeline capacity. The control setpoints may comprise, for each station being managed, a target flow rate, a target discharge pressure, and/or a target suction pressure to be used for control at each station.

Simulation module 320 may interface with optimization module 330, which may provide a graphical user interface between simulation module 320 and a user. Thus, user input 332 may be received via optimization module 330 and used for simulation in simulation module 320. For example, user input 332 may comprise operator preferences for optimizing the control setpoints of the metering stations along the pipeline, along with a specified set of conditions and/or gas nominations. Simulation module 320 may execute the simulation model with the specified conditions and/or nominations as inputs, and according to the specified preferences, to generate a set of recommended control setpoints. The set of recommended control setpoints may indicate what equipment to run and at what setpoints to run the equipment. Examples of preferences that may be specified include, without limitation, minimization of fuel usage, minimization of emissions, and/or minimization of operation and maintenance costs:
(1) Minimization of Fuel Usage. If minimization of fuel usage is a specified preference, the simulation may be executed to find a solution, based on a defined delivery pressure and flow rate, that minimizes fuel usage in the pipeline. In particular, the simulation model may be evaluated with the specified inputs to generate a set of recommended control setpoints. As long as the desired delivery conditions are within the available pipeline capacity (e.g., as predicted by simulation module 320) at the time being simulated, the solver will determine the best configuration of the operating equipment (e.g., as represented by the set of recommended control setpoints) to achieve the least amount of fuel flow in the pipeline. To achieve this solution, the solver may prioritize maintaining compressor discharge pressures as high as possible along the pipeline, which is a more efficient way to move gas in a gas transmission pipeline, while reducing the discharge pressures of the compressor(s) closest to the delivery point(s).
(2) Minimization of Emissions. If minimization of emissions is a specified preference, the simulation may be executed to find a solution, based on rated emissions of the equipment, that minimizes emissions in the pipeline. The emission ratings of the equipment may be based on known emission levels for the equipment from field testing, and may be automatically determined or user specified (e.g., via a graphical user interface). This preference may prioritize the operation of equipment with lower emission ratings, while reducing or shutting down operation of equipment with higher emission ratings when possible. To reduce fugitive emissions, the simulation may be constrained to prevent shutting down any compressor that would subsequently result in the venting of natural gas into the atmosphere. This can be implemented by maintaining operation of the given compressor, but setting a minimum positive flow through the compressor.
(3) Minimization of Operation and Maintenance Costs. If minimization of operation and maintenance costs is a specified preference, the simulation may be executed to find a solution, based on rated operating costs of the equipment, that minimizes operation and maintenance costs of the pipeline. The operating costs of the equipment may be automatically determined or user specified (e.g., via a graphical user interface). This preference may prioritize the operation of equipment with lower operating costs, while reducing or shutting down operation of equipment with higher operating costs when possible. This preference can be used to manage fired hour accumulation for gas turbines (e.g., to help an operator more efficiently plan for future turbine overhauls).

Once a set of recommended control setpoints has been output by simulation module 320, the control setpoints may be automatically (e.g., without user intervention), semi-automatically (e.g., with user confirmation), or manually sent to (e.g., over network(s) 120) a controller at each station. However, in an embodiment, for safety and security reasons, control of the stations is not entirely automatic. Rather, the control setpoints may be output from simulation module 320 to optimization module 330. Optimization module 330 may then generate a graphical user interface comprising the control setpoints as recommendations. Thus, a user may confirm and/or adjust the control setpoints (e.g., via one or more inputs) as needed, and then initiate a control operation for one or more stations via one or more inputs of the graphical user interface or via other communication means.

In an automatic or semi-automatic embodiment, once the control operation is initiated, optimization module 330 may transmit the control setpoints, representing optimized compression, to the station controller of each station involved in the control operation. Each station controller may receive the control setpoints and control the equipment (e.g., compressor) at the station to move towards and operate according to the control setpoints. For example, the station controller may output a driver speed command, as this is how most compressor stations on gas transmission pipelines are controlled. In a manual embodiment, a user may manually set or communicate the control setpoints to each station involved in the control operation.

In an embodiment, optimization module 330 may provide user-configurable hypothetical or “what-if” analysis that enable users to execute quick pipeline simulations using simulation module 320. This what-if analysis can be used to support decision-making by the pipeline operator. The what-if analysis may use the same methodology as the solvers for the pipeline capacity and control setpoints, but enables the user to substitute real-time equipment data 314 and/or real-time pipeline data 324 with hypothetical data to test out various what-if scenarios. Thus, for example, the user can utilize the what-if analysis to see what would happen in the pipeline under a potential upset condition, and plan accordingly. For example, if the operator is planning to shut down an item of equipment (e.g., for maintenance or replacement), the user may run a simulation without that item of equipment in order to view a prediction of available pipeline capacity without that item of equipment.

In an embodiment, optimization module 330 provides user-configurable notifications 334. For example, a user may set one or more criteria that should be used to trigger a notification 334, along with one or more destinations, via the graphical user interface. The criteria may represent upset conditions and/or deviations from optimal operation. The criteria may comprise a any number and combination of metrics related to compression optimization, including a value of the pipeline capacity, a value or sum of nominations 326, any monitored value in real-time pipeline data 324, and/or the like. Thus, users can individually select and define what criterion or combination of criteria should trigger a notification. As examples, a user could specify that a notification should be sent to the user when pipeline capacity drops below a certain threshold, pressure exceeds a certain threshold, or if the control setpoints deviate from optimal or expected control setpoints (e.g., indicative of equipment being run sub-optimally). Optimization module 330 may continually check (e.g., at specified intervals) the one or more criteria that have been set, and transmit a notification 334 to the destination(s) when the one or more criteria are satisfied. It should be understood that one or a plurality of notifications 334 may be configured in this manner by each of one or a plurality of users.

Notifications 334 may comprise any type or types of communication, including a Short Message Service (SMS) text, a Multimedia Messaging Service (MMS) text, an email message, an automated telephone call or voice message, and/or the like. It should be understood that the destination, set by a user, may be a communication address that corresponds to the type of communication, such as a mobile telephone number for SMS or MMS texts, an email address for email messages, and a telephone number for telephone calls or voice messages. Notifications 334 may be sent directly or indirectly by optimization module 330. In the indirect case, optimization module 330 may provide notifications 334 to an external system 140, such as the InSight Platform™ offered by Solar Digital of San Diego, Calif., to provide the notification functionality.

In an embodiment, server application 112 may store all or a portion of the real-time data that is received (e.g., real-time equipment data 314, real-time pipeline data 324, nominations 326) in persistent non-volatile memory (e.g., secondary memory 220). This historical data, which may include pipeline capacity, gas nominations, actual flow rates, actual setpoints, recommended setpoints, and/or the like, may enable users to review trends in the operation of the pipeline to support future planning and maintenance activities. In addition, this historical data or portions of this historical data may be used by self-learning module 328 as a training dataset to train the simulation model of simulation module 320.

During operation of the pipeline, the measure of real-time pipeline capacity may be displayed within a graphical user interface for viewing by an operator or other user. It should be understood that the measure of pipeline capacity may be displayed within the graphical user interface in combination with other metrics and/or parameters, such as nominations 326 and real-time pipeline throughput (e.g., comprised in or derived from real-time pipeline data 324), as well as with one or more inputs for running simulations. Thus, the user may compare the current pipeline capacity, gas nominations, and pipeline throughput to better understand the pipeline's current ability to meet customer needs, as well as run simulations for what-if analysis if necessary. This can be especially useful information for a user that is reacting to an operational upset condition (e.g., equipment failure).

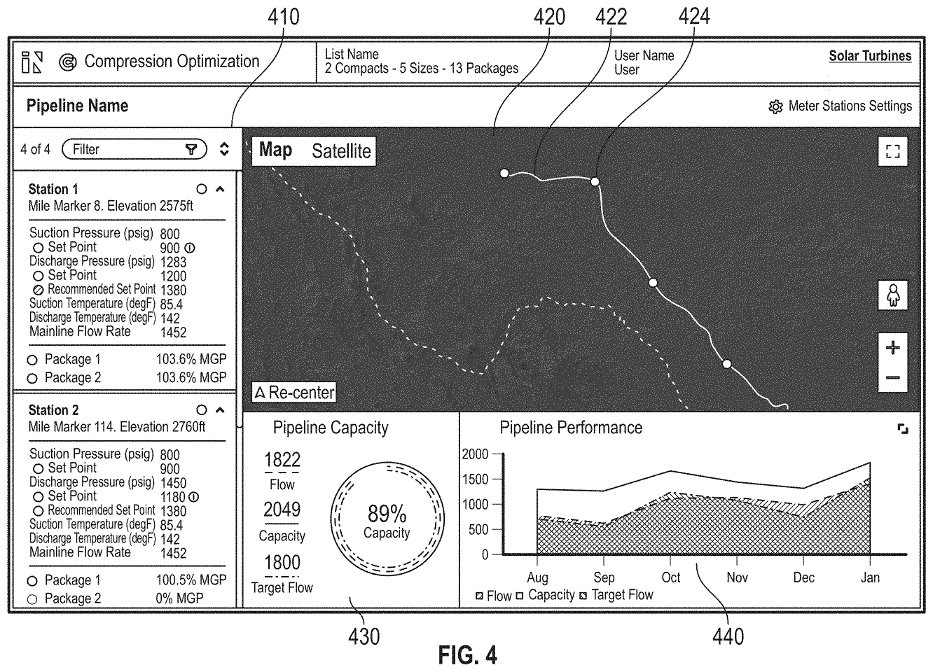

FIG. 4 illustrates an example graphical user interface that may be generated by optimization module 330, according to an embodiment. The illustrated graphical user interface presents relevant data to a user for decision-making about the operation of a pipeline in a simple, easy-to-understand format that even novice users can utilize. In an embodiment, the graphical user interface comprises a list 410 of stations along the pipeline, a virtual map 420 depicting the pipeline, pipeline capacity information 430, and pipeline performance information 440. While particular sections and a particular arrangement of sections are illustrated and described herein, it should be understood that different combinations of sections and arrangements may be used.

List 410 may comprise a searchable and scrollable list of all stations being managed along the pipeline for which compression optimization is being performed. For each station in list 410, the entry for the station may comprise a station identifier, a mile marker of the station, an elevation of the station, suction pressure at the station, the setpoint of suction pressure at the station, a discharge pressure at the station, the current setpoint of discharge pressure at the station, a recommended setpoint of discharge pressure at the station, a suction temperature at the station, a discharge temperature at the station, a flow rate at the station, one or more parameters for each equipment package at the station, and/or the like. Each station entry may be collapsible and expandable, so that the user can quickly focus on stations of interest. List 410 may also comprise a search input that enables the user to perform keyword searching of the stations in list 410. As the user inputs text into the search input, list 410 of stations may be updated to show only those stations that are associated with information matching the input text. Thus, the user can quickly narrow list 410 to only those stations matching specified keywords.

Virtual map 420 may represent the pipeline in the context of geographical topography, jurisdictional boundaries (e.g., countries, states, counties, cities, etc.), and/or landmarks (e.g., roads, rivers, etc.). The pipeline representation may comprise a line 422 representing the pipeline on virtual map 420, and points 424 along line 422, each representing a station along the pipeline. Virtual map 420 may comprise inputs for standard map functionality, such as switching between a map view and a satellite view, re-centering the pipeline representation within virtual map 420, expanding virtual map 420 to full screen, setting a street view, zooming into virtual map 420, zooming out of virtual map 420, and/or the like.

Pipeline capacity information 430 may comprise a representation of real-time or simulated pipeline capacity, and/or other values. For example, pipeline capacity information 430 may comprise a value and/or other representation of the current or simulated flow rate, pipeline capacity, and target flow rate. In the illustrated embodiment, pipeline capacity information 430 comprises numerical values for each of these parameters in a legend, as well as a graphical representation of each of these parameters. The graphical representation may comprise a circle representing the pipeline capacity, a partial to full circle (e.g., concentric and within the circle representing the pipeline capacity) representing the current flow rate, and a partial to full circle (e.g., concentric and within the circle representing the pipeline capacity) representing the target flow rate. It should be understood that the circles for flow rate and target flow rate will be partial if they are less than the pipeline capacity and will be full if they are at the pipeline capacity. Each circle may be represented in a color associated with the parameter in the legend, and each parameter may be represented by a different color.

Pipeline performance information 440 may comprise a graph representing pipeline performance over a time period. For example, in the illustrated embodiment, pipeline performance information 440 comprises a line graph representing real-time or simulated pipeline capacity, flow rate, and target flow rate over a time period (e.g., the most recent six months for real-time data). The line for each parameter represented in the line graph may be represented in the same color that is associated with that parameter in pipeline capacity information 430.

### INDUSTRIAL APPLICABILITY

In an embodiment, compression optimization system 300 is implemented as a software application (e.g., server application 112 and/or client application 132) that supports desktop and mobile computing systems (e.g., user systems 130). Compression optimization system 300 may be used by operators of gas transmission pipelines to reduce fuel usage, reduce emissions, reduce maintenance costs, and support cost-effective decision-making for day-to-day pipeline operations. A user may input desired gas delivery conditions and preferences, and compression optimization system 300 will provide predicted pipeline capacity and/or recommended control setpoints that optimize equipment usage according to the preferences. In addition, real-time pipeline capacity and/or other metrics can be tracked in real-time via a user-friendly graphical user interface. Users can be automatically notified (e.g., at a mobile user system 130) when conditions satisfy user-specified criteria (e.g., when specified gas delivery conditions have become compromised). The rate of capacity change, as determined via transient simulation, may also be provided to users to support decision-making related to correction of an operational issue. Integration of pipeline modeling algorithms with real-time pipeline data 324 and compression equipment performance analytics can facilitate pipeline models that are representative of real-world equipment in their existing conditions.

It will be understood that the benefits and advantages described above may relate to one embodiment or may relate to several embodiments. Aspects described in connection with one embodiment are intended to be able to be used with the other embodiments. Any explanation in connection with one embodiment applies to similar features of the other embodiments, and elements of multiple embodiments can be combined to form other embodiments. The embodiments are not limited to those that solve any or all of the stated problems or those that have any or all of the stated benefits and advantages.

The preceding detailed description is merely exemplary in nature and is not intended to limit the invention or the application and uses of the invention. The described embodiments are not limited to usage in conjunction with a particular type of pipeline. Hence, although the present embodiments are, for convenience of explanation, depicted and described as being implemented in a gas transmission pipeline, it will be appreciated that it can be implemented in various other types of fluid pipelines, and in various other systems and environments. Furthermore, there is no intention to be bound by any theory presented in any preceding section. It is also understood that the illustrations may include exaggerated dimensions and graphical representation to better illustrate the referenced items shown, and are not consider limiting unless expressly stated as such.

What is claimed is:

1. A system comprising:
at least one hardware processor;
a memory; and
one or more software modules that are configured to, when executed by the at least one hardware processor,
receive real-time pipeline data representing one or more parameters of a pipeline,
add the real-time pipeline data to historical pipeline data stored in the memory,
execute a simulation model of the pipeline based on the real-time pipeline data, and
generate one or more control setpoints, representing optimum compression, for one or more stations along the pipeline, based on an output of the simulation model.

2. The system of claim 1, wherein the one or more software modules are further configured to, in a self-learning phase, use machine learning to update the simulation model, using at least a portion of the historical pipeline data as a training dataset, to minimize a difference between the output of the simulation model and at least one parameter represented in the historical pipeline data.

3. The system of claim 1, wherein the simulation model comprises a steady-state model.

4. The system of claim 3, wherein the steady-state model comprises a plurality of models, wherein each of the plurality of models represents one of a plurality of segments of the pipeline.

5. The system of claim 1, wherein the one or more software modules are further configured to calculate at least one parameter of the pipeline based on the real-time pipeline data.

6. The system of claim 5, wherein the at least one parameter comprises a capacity of the pipeline and is calculated based on one or more of asset availability in the pipeline, gas conditions, gas constraints, or ambient conditions, as represented in the real-time pipeline data.

7. The system of claim 1, wherein the one or more software modules are further configured to execute the simulation model to predict at least one parameter of the pipeline as the output of the simulation model.

8. The system of claim 7, wherein the at least one parameter comprises a capacity of the pipeline, and wherein the simulation model is executed using input representing a user-defined scenario, wherein the input comprises one or more of asset availability in the pipeline, gas conditions, gas constraints, or ambient conditions.

9. The system of claim 1, wherein the one or more software modules are further configured to generate the one or more control setpoints to satisfy at least one preference.

10. The system of claim 9, wherein the one or more control setpoints comprise one or more of a target flow rate, a target discharge pressure, or a target suction pressure.

11. The system of claim 9, wherein the at least one preference comprises minimization of fuel usage.

12. The system of claim 9, wherein the at least one preference comprises minimization of emissions.

13. The system of claim 12, wherein generating the one or more control setpoints to satisfy minimization of emissions comprises prioritizing operation of equipment with lower emission ratings over operation of equipment with higher emission ratings during execution of the simulation model.

14. The system of claim 9, wherein the at least one preference comprises minimization of operation and maintenance costs.

15. The system of claim 14, wherein generating the one or more control setpoints to satisfy minimization of operation and maintenance costs comprises prioritizing operation of equipment with lower operating costs over operation of equipment with higher operating costs during execution of the simulation model.

16. The system of claim 1, wherein the simulation model comprises a transient model that predicts a rate of change in pipeline capacity, between two steady states, based on a change in one or more conditions of the pipeline.

17. The system of claim 16, wherein the one or more software modules are further configured to:
detect an upset condition represented in the real-time pipeline data; and,
in response to detecting the upset condition,
execute the transient model to predict a rate of change in pipeline capacity resulting from the upset condition, and
notify a user of the upset condition and the predicted rate of change in pipeline capacity resulting from the upset condition.

18. The system of claim 1, wherein the one or more software modules are further configured to:
receive a plurality of equipment models, wherein each of the plurality of equipment models represents an item of equipment in the pipeline;
generate an initial version of the simulation model based on the plurality of equipment models;
receive real-time equipment data for the equipment in the pipeline;
determine at least one condition of the equipment in the pipeline based on the real-time equipment data and the plurality of equipment models; and
update the simulation model based on the determined at least one condition.

19. A method comprising using at least one hardware processor to:
receive real-time pipeline data representing one or more parameters of a pipeline;
add the real-time pipeline data to historical pipeline data stored in a memory;
execute a simulation model of the pipeline based on the real-time pipeline data; and
generate one or more control setpoints, representing optimum compression, for one or more stations along the pipeline, based on an output of the simulation model.

20. A system comprising:
at least one hardware processor;
a memory; and
one or more software modules that are configured to, when executed by at least one hardware processor,
receive real-time pipeline data representing one or more parameters of a pipeline,
add the real-time pipeline data to historical pipeline data stored in the memory, and
use machine learning to update a simulation model, using at least a portion of the historical pipeline data as a training dataset, to minimize a difference between an output of the simulation model and at least one parameter represented in the historical pipeline data.
